(19) United States
(12) Patent Application Publication
(10) Pub. No.: US 2006/0212581 A1
(43) Pub. Date: Sep. 21, 2006

(54) Web server HTTP service overload handler

(75) Inventor: Kenneth Avery Coar, Raleigh, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/080,590

(22) Filed: Mar. 15, 2005

(51) Int. Cl. G06F 15/16

(52) U.S. Cl. 709/227

(57) ABSTRACT

A method, apparatus and computer instructions are provided for dealing with capacity exhaustion conditions. A module is which may be loaded into a Web server and invoked during its processing of requests. The module stores conditions under which the Web server should return a “Service Unavailable” status rather than continuing to process the request. An estimator is also provided that provides a time frame for which the user could try to obtain requested information at a later time.

### BACKGROUND OF THE INVENTION

1. Technical Field

The present invention relates generally to an improved data processing system and in particular to a method and apparatus for dealing with capacity exhaustion conditions. Still more particularly, the present invention provides a module that establishes conditions where a “Service Unavailable” status may be returned.

2. Description of Related Art

The Apache™ HTTP site server is open source server software which is HTTP compliant. The Apache™ HTTP server is a flexible and powerful server. The Apache HTTP server provides a flexible and highly configuring environment. It is highly compatible with third-party modules.

The Apache™ HTTP server can be easily customized by writing modules with the Apache™ HTTP server's module API. Actually, the Apache™ HTTP server has an unrestrictive license and it provides full source code. The Apache™ HTTP server is compatible with many operating systems. Some of the compatible operating systems are Linux®, Windows® 95, Windows® 98, Windows NT®, Windows 2000®, Windows XP®, OS/2™ , Netware® (“5.x” and above), UNIX®, many versions of UNIX®-like operating systems, and upcoming operating systems. The Apache™ HTTP server development organization supports patches and bug reports and greatly enhances user feedback.

The Apache™ HTTP server supports latest protocols, including “HTTP 1.1”. The Apache™ HTTP server can be considered as one of the fastest, most functional, and most efficient Web servers available today.

The Apache™ HTTP server is a stable Web server. It is more feature-full than many other Web servers available today. When compared to other Web servers, the main merit of the Apache™ HTTP server is that it is available free of cost. Other Web servers usually cost thousands of dollars. In terms of functionality, the Apache™ HTTP server stands at a high level. Some Web server companies point out that the speed of the ApacheTM HTTP server is not at all satisfactory.

But many reports claim that the Apache™ HTTP server is run on sites that get millions of hits per day, and they have not found any performance difficulties. An Internet report says that the Apache™ HTTP server is run on over 6 million Internet servers. The product has been tested thoroughly both by developers and users. The Apache™ Software Foundation is the organization which releases new versions of the Apache™ HTTP server. The Apache™ Software Foundation is very prompt and whenever they find bug reports, they release patches immediately.

However, as distributed, the Apache™ HTTP server includes no packaged functionality to deal gracefully with capacity exhaustion conditions. The HTTP protocol provides a status code (503, “Service Unavailable”) for capacity exhaustion conditions, but the Apache™ HTTP server, which is running over 60 percent of the world's Web servers, does not make user of this code. Currently, the Apache™ HTTP server responds to capacity exhaustion conditions with a low-level error codes such as “Connection Refused.” Thus, it would be advantageous to provide a way of dealing with capacity exhaustion conditions in a more graceful way.

### BRIEF SUMMARY OF THE INVENTION

The present invention provides a method, apparatus and computer instructions for dealing with capacity exhaustion conditions. A module may be loaded into a Web server and invoked during its processing of requests. Conditions under which the Web server should return a “Service Unavailable” status are established rather than continuing to process the request. An estimator is used in which the estimator provides a time frame for which the user could try to obtain requested information at a later time.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram of a data processing system in which the present invention may be implemented;

FIG. 4 is a block diagram of data processing system in which capacity exhaustion conditions are dealt with through the policies that exist within a module in a Web server in accordance with a preferred embodiment of the present invention; and

FIG. 5 is a flowchart illustrating an exemplary operation in which capacity exhaustion conditions are dealt with in accordance with a preferred embodiment of the present invention.

### DETAILED DESCRIPTION OF THE INVENTION

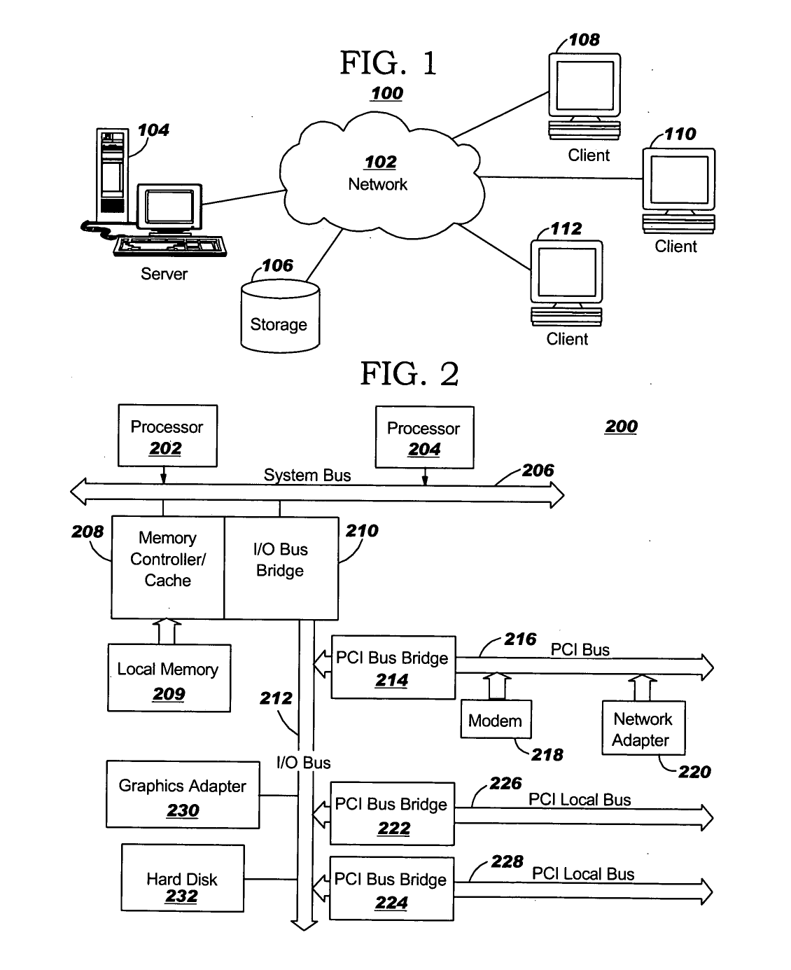

The present invention provides a method, apparatus and computer instructions for dealing with capacity exhaustion conditions. The data processing device may be a stand-alone computing device or may be a distributed data processing system in which multiple computing devices are utilized to perform various aspects of the present invention. Therefore, the following FIGS. 1-3 are provided as exemplary diagrams of data processing environments in which the present invention may be implemented. It should be appreciated that FIGS. 1-3 are only exemplary and are not intended to assert or imply any limitation with regard to the environments in which the present invention may be implemented. Many modifications to the depicted environments may be made without departing from the spirit and scope of the present invention.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as Web pages, to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pSeries® system, a product of International Business Machines Corporation in Armonk, N.Y., running the Advanced Interactive Executive (AIX™) operating system or Linux® operating system.

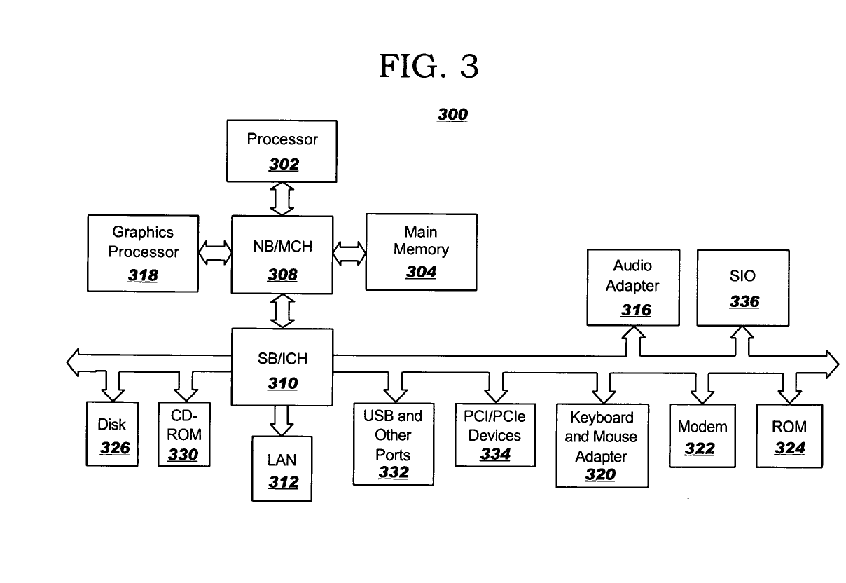

With reference now to FIG. 3, a block diagram of a data processing system is shown in which the present invention may be implemented. Data processing system 300 is an example of a computer, such as server 104 or client 108 in FIG. 1, in which code or instructions implementing the processes of the present invention may be located. In the depicted example, data processing system 300 employs a hub architecture including a north bridge and memory controller hub (MCH) 308 and a south bridge and input/output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, local area network (LAN) adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 may be connected to ICH 310. PCI/PCIe devices may include, for example, Ethernet adapters, add-in cards, PC cards for notebook computers, etc. PCI uses a cardbus controller, while PCIe does not. ROM 324 may be, for example, a flash binary input/output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and is used to coordinate and provide control of various components within data processing system 300 in FIG. 3. The operating system may be a commercially available operating system such as Windows XP™, which is available from Microsoft Corporation. Instructions for the operating system and applications or programs are located on storage devices, such as hard disk drive 326, and may be loaded into main memory 304 for execution by processor 302. The processes of the present invention are performed by processor 302 using computer implemented instructions, which may be located in a memory such as, for example, main memory 304, memory 324, or in one or more peripheral devices 326 and 330.

Those of ordinary skill in the art will appreciate that the hardware in FIG. 3 may vary depending on the implementation. Other internal hardware or peripheral devices, such as flash memory, equivalent non-volatile memory, or optical disk drives and the like, may be used in addition to or in place of the hardware depicted in FIG. 3. Also, the processes of the present invention may be applied to a multiprocessor data processing system.

The depicted example in FIG. 3 and above-described examples are not meant to imply architectural limitations. For example, data processing system 300 also may be a tablet computer or laptop computer.

The present invention provides a method, apparatus and computer instructions for dealing with capacity exhaustion conditions. A module is provided which may be loaded into an Apache™ HTTP server and invoked during its processing of requests. The module incorporates mechanisms which interpret Webmaster-set policies that establish conditions under which the Web server should return a “Service Unavailable” status rather than continuing to process the request. The mechanisms in the module examine system conditions at the time of the request, and compare them with thresholds set by the policies. The module can modify the status to include a “try again later” time interval if such a policy is provided by the Webmaster.

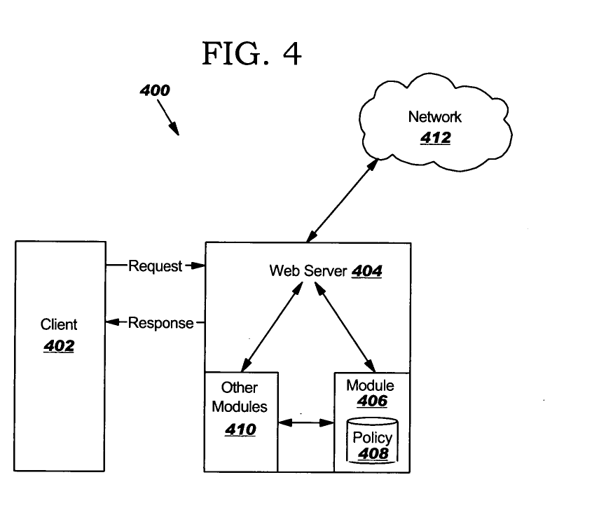

With reference now to FIG. 4, block diagram of data processing system 400 is shown in which capacity exhaustion conditions are dealt with through policy implementations that exist within a module in an Apache™ HTTP server in accordance with a preferred embodiment of the present invention. Client 402, which corresponds to one of clients 108, 110 and 112 of FIG. 1, sends a request for information to Web server 404, which relates to server 104 of FIG. 1. Web server 404 reads the request to determine the information that is being requested by client 402. At this point, a module 406, which may be named mod_refuse, is invoked by Web server 404. Module 406 contains a policy database 408 which defines capacity exhaustion conditions under which a status code 503, “Service Unavailable”, may be returned to client 402 if one or more of the capacity exhaustion conditions are met at the time of the request.

Web server 404 continues to process the request to obtain the information for client 402. The configuration of the Web server may call for the policy module 408 to be invoked zero or more times during the processing of the request, with identical or different policies at each invocation. If during such an invocation policy module 408 determines that one or more of its policies has been violated, processing of the request is stopped and status code 503, “Service Unavailable”, is returned to client 402. If no condition is met during these operations, then the request is handled normally by other server modules 410. After the requested information is retrieved, it is sent back from network 412 to Web server 404.

If there is any condition that is met based on the code that is running during the compiling of the response by Web server 404 that is to be sent to client 402, a status code 503, “Service Unavailable”, is returned to client 402. Otherwise, the compiled response is sent to client 402. Although many capacity exhaustion conditions may be defined in policy database 408, some exemplary capacity exhaustion conditions may be when the load average of Web server 404 exceeds a specified value, when the excess capacity of Web server 404 is too small, when available storage space is below a specific threshold, or by the existence or non-existence of an environmental value. These conditions may be defined by a Web server administrator or by other Web server components. Environmental variables may be imported into policy database 408 through environment variables that are set in other modules 410.

Furthermore, other portions of Web server 404 may provide feedback to module 406 which provides information to define other capacity exhaustion conditions that may be expressed in policy database 408. Thus, policy database 408 may contain capacity exhaustion conditions other than those exemplary capacity exhaustion conditions provided here. The policy database also permits the Webmaster to specify whether a status 503, “Service Unavailable”, response should include a client-readable instruction to “Try again after time t.” This delay indication which facilitates automation in the processing of client requests may reduce the burden that causes capacity exhaustion on Web server 404 and the burden of users using client 402 of having to remember to try loading the requesting information again.

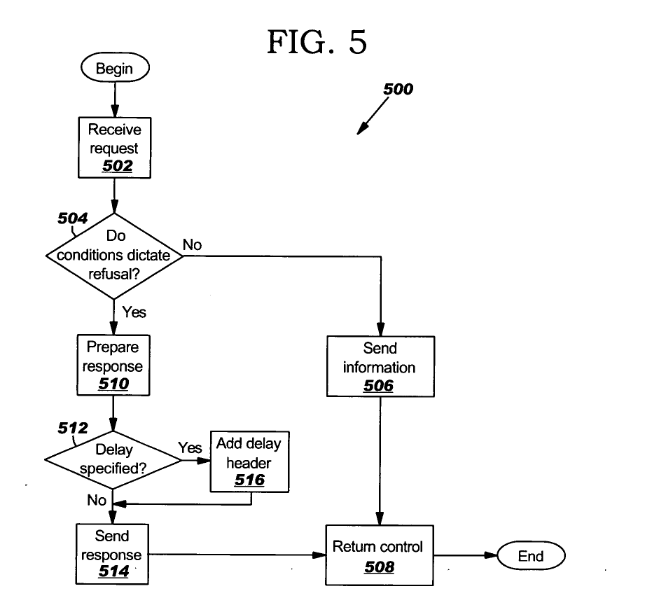

Turning now to FIG. 5, flowchart illustrates an exemplary operation in which capacity exhaustion conditions are dealt with in accordance with a preferred embodiment of the present invention. The following operation is performed in Web server 404 of FIG. 4. As the operation begins, a request is received from a client such as client 402 of FIG. 4 (step 502). The requested information is sent to the client (step 506). The information in step 506 may be sent at as long as capacity exhaustion is not dictated (step 504). Examples of times at which capacity exhaustion may be dictated is when the header of the request being read by the Web server, when other modules analyzing the header of the request, or when the response being compiled by the Web server. Then control is returned to the Web server (step 508).

Returning to step 504, if a capacity exhaustion condition is dictated, a 503, “Service Unavailable” response is prepared to be sent to the client (step 510). As part of the preparation of the response (step 510), a check is made as to whether a time can be specified when the client should re-issue the request (step 512). If a time can not be specified as to when the request may be retried, a response indicating 503, “Service Unavailable” is inserted in the Web server's response queue (step 514) and control is returned to the Web server (step 508). Returning to step 512, If a time can be specified as to when the request may be retried, a delay header such as “Try again after time t” is added (step 516) to the 503, “Service Unavailable” response. The response indicating 503, “Service Unavailable” is inserted in the Web server's response queue (step 514) and control is returned to the Web server (step 508). Other modules such as other modules 410 of FIG. 4 may subsequently be invoked by the Web server and may modify the response.

Thus, the present invention provides a method, apparatus and computer instructions for dealing with capacity exhaustion conditions. A module is provided which may be loaded into a Web server and invoked during its processing of requests. The module contains policies that establish conditions under which the Web server should return a “Service Unavailable” status rather than continuing to process the request.

Therefore, the present invention provides a more descriptive response to a user if a condition exists in which the capacity of the Web server is exhausted, rather than responding to the user with a generic and potentially uninformative response such as “Connection Refused.” The present response may lead the user to believe they do not have authority to access the requested information. Additionally, the present invention permits the specification of a time when the user may retry the request when the server is less congested.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for dealing with capacity exhaustion conditions, the method comprising:
receiving a request from a client;
responsive to receiving the request, determining whether an indication of a capacity exhaustion condition has been generated by code in the data processing system;
responsive to the presence of the indication of the capacity exhaustion condition, generating a response describing the capacity exhaustion condition, wherein the response is generated using a policy; and
sending a reply to the client with the response indicating the capacity exhaustion condition.

2. The method of claim 1, further comprising:
in response to an absence of an indication of the capacity exhaustion condition, compiling information requested in the request; and
sending a reply to the client with the information.

3. The method of claim 1, wherein the generating step is performed in a module.

4. The method of claim 1, wherein the generating a response step also includes:
determining a time when the request may be resubmitted, wherein the time is determined based on the code that indicated the capacity exhaustion condition; and
sending a reply to the client with the time when the request may be resubmitted.

5. The method of claim 4, wherein the recommended resubmission time is specified by an administrator.

6. The method of claim 1, wherein the capacity exhaustion condition is specified by an administrator.

7. The method of claim 6, wherein the capacity exhaustion conditions is at least one of when a load average of a Web server exceeds a specified value, when an excess capacity of the Web server is insufficient to handle the request, an existence of an environmental value, and a non-existence of an environmental value.

8. The method of claim 1, wherein the capacity exhaustion condition is specified by a Web server component.

9. The method of claim 8, wherein the capacity exhaustion conditions is at least one of when a load average of a Web server exceeds a specified value, when an excess capacity of the Web server is insufficient to handle the request, an existence of an environmental value, and a non-existence of an environmental value.

10. The method in claim 1, wherein the response is a 503, “Service Unavailable” status code.

11. A data processing system comprising:
a bus system;
a communications unit connected to the bus system;
a memory connected to the bus system, wherein the memory includes a set of instructions; and
a processing unit connected to the bus system, wherein the processing unit executes the set of instructions to receive a request from a client; determine whether an indication of a capacity exhaustion condition has been generated by code in the data processing system responsive to receiving the request; generate a response describing the capacity exhaustion condition in response to the presence of the indication of the capacity exhaustion condition, wherein the response is generated using a policy; and send a reply to the client with the response indicating the capacity exhaustion condition.

12. The data processing system of claim 11, wherein the processing unit further executes a set of instructions to compile information requested in the request in response to an absence of an indication of the capacity exhaustion condition; and send a reply to the client with the information.

13. The data processing system of claim 11, wherein the set of instructions to generate a response also includes:
a set of instructions to determine a time when the request may be resubmitted, wherein the time is determined based on the code that indicated the capacity exhaustion condition; and send a reply to the client with the time when the request may be resubmitted.

14. The data processing system of claim 11, wherein the capacity exhaustion condition is specified by at least one of an administrator or a Web server component.

15. The data processing system of claim 11, wherein the response is a 503, “Service Unavailable” status code.

16. A computer program product for dealing with capacity exhaustion conditions, the computer program product comprising:
instructions for receiving a request from a client;
responsive to receiving the request, instructions for determining whether an indication of a capacity exhaustion condition has been generated by code in the data processing system;
responsive to the presence of the indication of the capacity exhaustion condition, instructions for generating a response describing the capacity exhaustion condition, wherein the response is generated using a policy; and
instructions for sending a reply to the client with the response indicating the capacity exhaustion condition.

17. The computer program product of claim 16, further comprising:
in response to an absence of an indication of the capacity exhaustion condition, instructions for compiling information requested in the request; and
instructions for sending a reply to the client with the information.

18. The computer program product of claim 16, wherein the instructions for generating a response also includes:
instructions for determining a time when the request may be resubmitted, wherein the time is determined based on the code that indicated the capacity exhaustion condition; and
instructions for sending a reply to the client with the time when the request may be resubmitted.

19. The computer program product of claim 16, wherein the capacity exhaustion condition is specified by at least one of an administrator or a Web server component.

20. The computer program product in claim 16, wherein the response is a 503, “Service Unavailable” status code.
